(19) United States
(12) Patent Application Publication
(10) Pub. No.: US 2023/0369885 A1
(43) Pub. Date: Nov. 16, 2023

(54) LIMITING RECOVERY CURRENT ON A POWER SUPPLY UNIT

(71) Applicant: Microsoft Technology Licensing, LLC, Redmond, WA (US)

(72) Inventors: Haowei HSU, Mercer Island, WA (US); John Joseph SIEGLER, Carnation, WA (US); Banha SOK, Kirkland, WA (US); Caroline Elizabeth LICHTENBERGER, Redmond, WA (US); Joseph Alek PIASECKI, North Bend, WA (US); Scot HEATH, Fort Collins, CO (US)

(21) Appl. No.: 17/744,130

(22) Filed: May 13, 2022

(51) Int. Cl. H02J 9/06; G06F 1/30; G06F 1/3296

(52) U.S. Cl. CPC H02J 9/06; G06F 1/30; G06F 1/3296

(57) ABSTRACT

A recovery current controller sets a recovery current cap for a power supply unit (PSU) based on power usage of a server. The power usage is determined based on the power consumption of the server, such as before, during, or after a switch from a default power feed to a backup power feed. The recovery current cap is less than a maximum available power of the PSU, thereby reducing or preventing tripped breakers and/or damaged bulk capacitors.

### CROSS-REFERENCE TO RELATED APPLICATIONS

N/A.

### BACKGROUND

A cloud computing system refers to a collection of computing devices capable of providing remote services and resources. For example, modern cloud computing infrastructures often include a collection of physical server devices organized in a hierarchical structure including computing zones, virtual local area networks (VLANs), racks, fault domains, etc. These cloud computing infrastructures may provide computing resources to users including a variety of processors, memory, and storage devices capable of providing different services to users of the cloud computing system.

Cloud computing infrastructure often include a default power feed and a backup power feed. The default power feed may be the primary power source of the infrastructure. The default power feed may have less than 100% availability. To maintain operations when the default power feed loses power, the infrastructure may switch to a backup power feed. The switch between the default power feed and the backup power feed may occur over a period of time, such as 10 milliseconds, 20 milliseconds, 30 milliseconds, 40 milliseconds, 50 milliseconds, or more. During this time, to prevent loss of operations of the computing devices, one or more stored power devices provide power to the computing devices. For example, a bulk capacitor may have a fast discharge time, and may provide power to the computing devices during the switch between the default power feed and the backup power feed.

After the switch is complete, the bulk capacitor is recharged using a recovery current. The recovery current causes a spike in the power supply to the computing devices, which may trip breakers and/or damage the bulk capacitor or other elements of the cloud computing system.

### BRIEF SUMMARY

In some embodiments, a method for limiting recovery current of a power supply unit (PSU) includes monitoring power of a PSU to a computing device. A loss of power to the computing device is determined. Based on a power consumption of the computing device, a recovery current cap is set for the PSU.

In other embodiments, a PSU includes an input power configured to supply power to a computing device. The computing device has an anticipated power consumption. The PSU has a maximum available power that is at least three times the anticipated power consumption. A bulk capacitor is configured to provide power to the computing device during a switch between a default power feed and a backup power feed. The PSU includes instructions which cause a processor to set a recovery current cap that is less than the maximum available power.

In yet other embodiments, a method for limiting recovery current of a PSU includes, at a computing device, determining a power consumption of the computing device. Based on the power consumption, a recovery current cap is determined. The recovery current cap is transmitted to a PSU.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a representation of an environment of a cloud computing system, according to at least one embodiment of the present disclosure;

FIG. 2 is a representation of a server having a recovery current controller, according to at least one embodiment of the present disclosure;

FIG. 3 is a representation of a PSU, according to at least one embodiment of the present disclosure;

FIG. 4 is a flowchart of a method for limiting recovery current, according to at least one embodiment of the present disclosure;

FIG. 5 is a flowchart of a method for limiting recovery current, according to at least one embodiment of the present disclosure;

FIG. 6 is a representation of a recovery current controller, according to at least one embodiment of the present disclosure;

FIG. 7 is a representation of a method for limiting recovery current, according to at least one embodiment of the present disclosure; and

FIG. 8 is a representation of a computing system, according to at least one embodiment of the present disclosure.

### DETAILED DESCRIPTION

This disclosure generally relates to devices, systems, and methods for recovery current management in data centers for cloud computing systems. During a power interruption, a power supply unit (PSU) may switch from default to battery power. A bulk capacitor may be drained while providing power to the computing device during the switch between default and secondary power sources. When power is restored, a recovery current controller may set the recovery current to a value that is less than the maximum recovery current. This may help to reduce the recovery current, thereby reducing the tripping of breakers and/or preventing damage to the bulk capacitors.

In accordance with at least one embodiment with the present disclosure, the recovery current may be based on the power draw from the computing device. For example, the recovery current may be based on the rated power draw based on the configuration of the server. In some examples, the recovery current may be based on the actual power draw of the computing device. In some examples, the recovery current may be based on the rate of change in voltage of the bulk capacitor.

In some embodiments, the recovery current may be set at the PSU. For example, a recovery current controller may be installed in the PSU. The recovery current controller may actively monitor the power supplied to the computing device. For example, the recovery current controller may be connected to a power sensor for the PSU, and the recovery current controller may periodically receive power sensor measurements from the power sensor to determine the power supply. When the default power feed to the computing device is interrupted (e.g., when the default power feed loses power), the recovery current controller may determine the power draw of the computing device during the switch between the default and the secondary power. The recovery current controller may then set the recovery current based on the power draw of the computing device. For example, the recovery current controller may set the recovery current to a percentage above the power draw, such as 5%, 10%, 15%, 20%, or any other percentage above the power draw. This may help to reduce tripped breakers and/or damage to the power system caused by the recovery current.

In some embodiments, the recovery current may be set using firmware installed in the PSU. For example, the firmware in the PSU may include various power configurations of the connected servers with associated recovery currents. The PSU may detect the configuration of the connected server, and use the associated recovery current.

In some embodiments, the recovery current may be set at the computing device. A recovery current controller may be located at the computing device. The recovery current controller may detect the loss of input power from the default power feed. The recovery current controller may transmit the power draw and an associated recovery current of the computing device to the PSU if the input power drops. In some embodiments, the recovery current controller may be installed at the baseboard management controller (BMC).

As illustrated by the foregoing discussion, the present disclosure utilizes a variety of terms to describe features and advantages of the recovery current controller. Additional detail is now provided regarding the meaning of such terms. For example, as used herein, the term “power supply unit (PSU)” refers to a device that directs power from a default power feed and a backup power feed to a computing device. The PSU may include a switch between the default and the backup power feeds. In some embodiments, a single server may include a single PSU. In some embodiments, a single PSU may provide power to multiple servers.

As used herein, the term “bulk capacitor” may refer to an alternative power source that is configured to provide power to the computing device during a switch between the default and backup power sources. In some embodiments, the bulk capacitor may include a capacitor, super capacitor, electrolytic capacitor, battery, or other power storage media. The bulk capacitor may provide a fast-acting power source for the computing device to maintain continuity of operation while the PSU switches from default to backup power, thereby preventing loss of function of the server when the default power feed loses power. In some embodiments, the bulk capacitor may be a part of the PSU. In some embodiments, the bulk capacitor may be part of an uninterruptable power supply (UPS).

As used herein, the term “recovery current” may relate to the amount of power supplied after a power loss event. The recovery current may include the current to power the computing device. The recovery current may further include the current to recharge the bulk capacitor. In some embodiments, the recovery current may be supplied by the default power feed. In some embodiments, the recovery current may be supplied by the backup power feed.

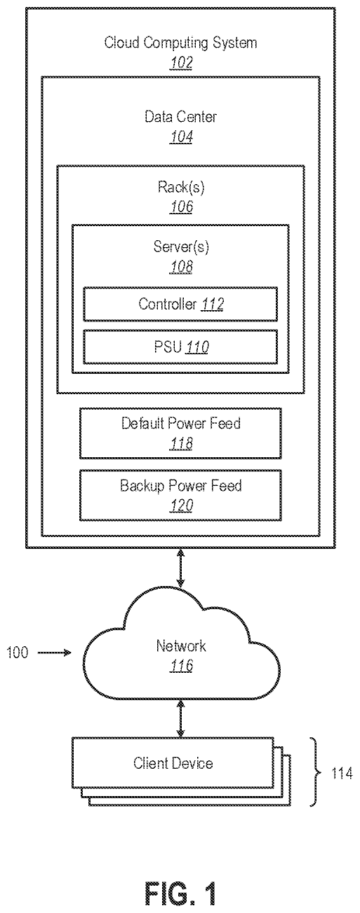

Additional detail will now be provided regarding power management of a storage system on a cloud computing system in relation to illustrative figures portraying example implementations. For example, FIG. 1 illustrates an example environment 100 including a cloud computing system 102 that provides a variety of computing services to users of the cloud computing system 102. As shown in FIG. 1, the cloud computing system 102 includes a data center 104 having one or more racks 106 of servers 108. The servers 108 (e.g., computing nodes) may include hardware and/or software components for providing features and functionality described herein. In the example shown in FIG. 1, the server 108 may include a PSU 110 and a recovery current controller 112.

As further shown, the environment 100 may include a plurality of client devices 114 in communication with the cloud computing system 102 (e.g., in communication with one or more servers 108 and/or virtual machines hosted thereon via a network 116). The client devices 114 may refer to various types of client devices. For instance, a client device may refer to a mobile device such as a mobile telephone, a smart phone, a personal digital assistant (PDA), a tablet, a laptop, or wearable computing device (e.g., a headset or smartwatch). A client device may also refer to a non-mobile device such as a desktop computer, a server node (e.g., from another cloud computing system), or other non-portable device.

The network 116 may include one or multiple networks that use one or more communication platforms or technologies for transmitting data. For example, the network 116 may include the Internet or other data link that enables transport of electronic data between respective client devices 114 and components (e.g., server 108 and/or virtual machines thereon) of the cloud computing system 102.

The data center 104, racks 106, and/or servers 108 may be powered using a default power feed 118. The default power feed 118 may provide the main power to the data center 104. To provide power to the servers 108, the PSU 110 may receive power from the default power feed 118 and direct it to the servers 108. The data center 104 further includes a backup power feed 120. The backup power feed 120 may provide power to the data center 104 in the event the default power feed 118 stops providing power to the data center 104 (e.g., the default power feed 118 “drops,” loses power, or otherwise stops providing power to the data center 104). The PSU 110 may receive power from the backup power feed 120 and switch between the default power feed 118 and the backup power feed 120.

In some embodiments, the servers 108 may provide stored intermediate power during the switch between the default power feed 118 and the backup power feed 120. For example, the servers 108 may include an uninterruptable power supply (UPS), a battery, a bulk capacitor, or other mechanism to provide stored intermediate power during the switch between the default power feed 118 and the backup power feed 120. In some embodiments, the intermediate power may be part of the PSU 110.

When the default power feed 118 loses power, the stored intermediate power may be at least partially drained during the switch between the default power feed 118 and the backup power feed 120. After the switch between the default power feed 118 and the backup power feed 120 is made, the reconnected power may recharge the stored intermediate power with a recovery current.

In some situations, the recovery current may be greater than the power used to power the servers 108 before, during, and/or after the default power feed 118 lost power. Conventionally, the recovery current is set based on the maximum available power supplied by the default power feed 118 and/or the backup power feed 120. For example, if the default power feed 118 and/or the backup power feed 120 are configured to supply 1000 W of power to a particular server 108, the recovery current may be some amount above this maximum available power, such as 1200 W.

In some situations, a server 108 may have a power rating. The power rating of the server 108 may be the amount of power the server 108 is configured to utilize in a particular configuration. In some embodiments, the power rating of the server 108 may be the maximum power the server 108 may utilize. In some embodiments, the power rating of the servers 108 may be less than the maximum power based on the setup of the server 108, such as a compute node or a storage node. In some embodiments, the power rating of the server 108 may be less than the maximum available power. Put another way, the PSU 110 may be overpowered relative to the server 108, or configured to supply 2 times, 2.5 times, 3 times, 4, times, 5 times, 6 times, 7 times, 8 times, 9 times, 10 times, or more, more power to the server 108 than the power rating of the server 108.

Conventionally, the recovery current is set based on the maximum available power of the PSU 110. When the PSU 110 is overpowered relative to the server 108, then the recovery current may be significantly higher than the standard current supplied to the server 108. In some situations, after a switch in power between the default power feed 118 and the backup power feed 120, the recovery current may cause a spike in the power supplied to the data center 104. A high recovery current may result in breakers tripping, which may result in loss of service of the data center 104. In some situations, a high recovery current may result in damage to the storage intermediate power, such as the bulk capacitor. In some situations, when the default power feed 118 loses power, all of the servers 108 on a rack 106, and even multiple (or all) racks 106 in a data center 104 may lose power. If multiple PSUs 110 are overpowered, then a large number of servers 108, racks 106, and even the entire data center 104 may be damaged.

In accordance with at least one embodiment of the present disclosure, the recovery current controller 112 may set a recovery current cap for the PSU 110. The recovery current cap may be the maximum current the recovery current controller may allow the PSU 110 to provide. For example, the recovery current cap may be 1 A, 2 A, 3 A, 4 A, 5 A, 6 A, 8 A, 10 A, 12 A, 14 A, 16 A, 18 A, 20 A, or any value therebetween. The recovery current cap may place a limit on the recovery current after the PSU 110 switches between the default power feed 118 and the backup power feed 120. This may help to reduce the power spike caused by the recovery current recharging the stored intermediate power. In this manner, fewer breakers may be tripped and/or the stored intermediate power may not be damaged. This may significantly reduce the operating costs of the data center 104, including decreasing downtime of the data center 104, thereby saving money due to fewer lost revenues based on the data center 104 going down. In some embodiments, reducing the power spike may help to reduce the cost of power based on an increased cost of electricity for power spikes.

In some embodiments, the recovery current controller 112 may set the recovery current cap based on the active power consumption of the server 108. For example, the recovery current controller 112 may set the recovery current cap based on the rate of discharge of the stored intermediate power. In some examples, the recovery current controller 112 may set the recovery current cap based on the power consumption of the server 108 prior to the default power feed 118 dropping power. In some examples, the recovery current controller 112 may set the recovery current cap based on the power consumption of the server 108 while recharging the stored intermediate power. In some examples, the recovery current controller 112 may set the recovery current cap based on the anticipated power consumption of the server 108. As used herein, the anticipated power consumption of the server 108 may be the rated power of the server 108 based on a particular configuration of the server 108. Different configurations may have different anticipated power consumptions, and the anticipated power consumption may be different than the maximum power consumption of the server 108.

As discussed herein, the recovery current controller 112 may be located at any location in the server 108. For example, the recovery current controller 112 may be located in the PSU 110. In some examples, the recovery current controller 112 may be installed as firmware in the PSU 110. In some examples, the recovery current controller 112 may be located in the server 108 and the server 108 may transmit the recovery current cap to the PSU 110.

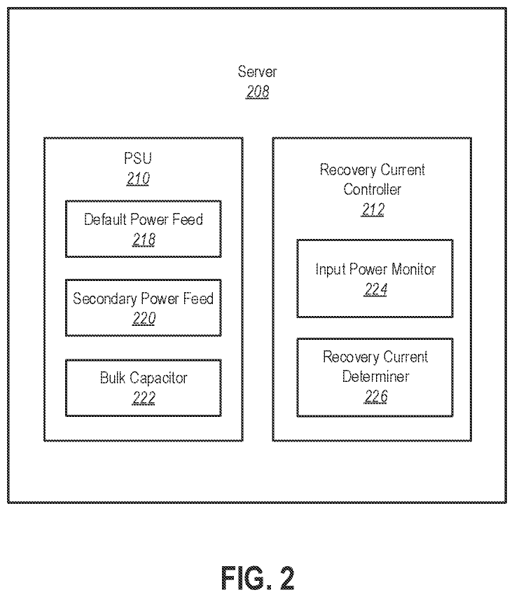

FIG. 2 is a representation of a server 208, according to at least one embodiment of the present disclosure. Each of the components of the server 208 can include software, hardware, or both. For example, the components can include one or more instructions stored on a computer-readable storage medium and executable by processors of one or more computing devices, such as a client device or server device. When executed by the one or more processors, the computer-executable instructions of the server 208 can cause the computing device(s) to perform the methods described herein. Alternatively, the components can include hardware, such as a special-purpose processing device to perform a certain function or group of functions. Alternatively, the components of the server 208 can include a combination of computer-executable instructions and hardware.

Furthermore, the components of the server 208 may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

The server 208 includes a PSU 210 that may direct power to the computing components of the server 208. The PSU 210 may direct power using a default power feed 218 and a secondary power feed 220. In some embodiments, if the default power feed 218 loses power, the PSU 210 may redirect power to the server 208 from the secondary power feed 220. The switch between the default power feed 218 and the secondary power feed 220 may occur over a period of time. To maintain operation of the server 208 during the switch between the default power feed 218 and the secondary power feed 220, the PSU 210 may use stored intermediate power, such as a bulk capacitor 222, to provide power to the server 208.

The server 208 further includes a recovery current controller 212. As discussed herein, the recovery current controller 212 may be located at the PSU 210 or at the server 208. The recovery current controller 212 may include an input power monitor 224. The input power monitor 224 may monitor the input power to the server 208 (e.g., the power output of the PSU 210). In some embodiments, the input power monitor 224 may continuously monitor the input power to the server 208. For example, the input power monitor 224 may monitor the input power to the server 208 to determine when the default power feed 218 loses power, indicating that the PSU 210 is switching to the secondary power feed 220 to power the server 208.

In some embodiments, the recovery current controller 212 may include a recovery current determiner 226. When the input power monitor 224 determines that the default power feed 218 has lost power, the recovery current determiner 226 may determine a recovery current cap for the secondary power feed 220. In some embodiments, the recovery current determiner 226 may determine the recovery current cap for the secondary power feed 220 based on the power consumption of the server 208.

The recovery current determiner 226 may determine the recovery current cap based on any metric of power consumption of the server 208. For example, as discussed herein, the input power monitor 224 may collect measurements of power draw of the server 208. The recovery current determiner 226 may use the collected power measurements to determine the recovery current cap. As discussed herein, the recovery current determiner 226 may use the measured power consumption of the server 208 at any time. For example, the recovery current determiner 226 may use the measured power consumption during discharge of the bulk capacitor 222. In some examples, the input power monitor 224 may measure the rate of change of voltage of the bulk capacitor 222 over time to determine the power consumption of the server 208. In some examples, the input power monitor 224 may measure the power consumption of the server 208 after the switch between the default power feed 218 and the secondary power feed 220 and while the bulk capacitor 222 is being charged. The recovery current determiner 226 may actively adjust the recovery current cap based on the current power consumption of the server 208. In some examples, the recovery current determiner 226 may use an average power consumption of the server 208. In some embodiments, the recovery current determiner 226 may use the anticipated power consumption or power rating of the server 208 to set the recovery current cap.

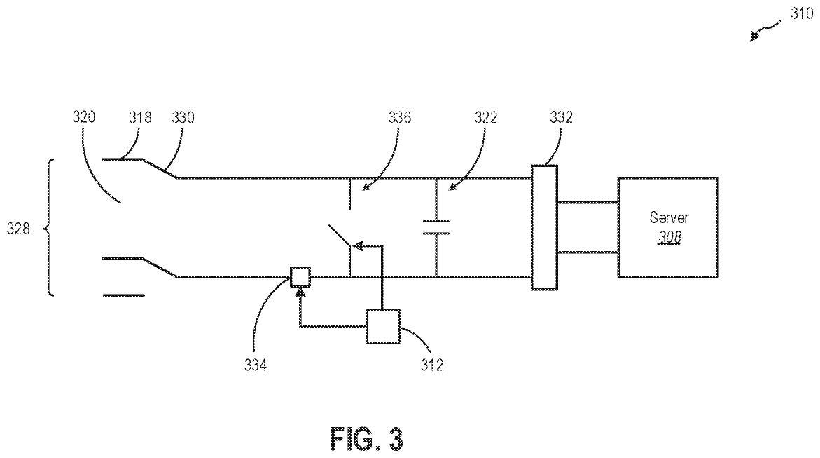

FIG. 3 is a schematic line diagram of a PSU 310, according to at least one embodiment of the present disclosure. The PSU 310 includes a power input 328. The power input 328 includes a default power feed 318 and a backup power feed 320. A switch 330 may switch the power input 328 between the default power feed 318 and the backup power feed 320. The power input 328 may provide power (e.g., output power of the PSU 310) to a server 308. An output converter 332 may convert the input from the power input 328 to the voltage used by the server 308.

The PSU 310 may include a recovery current controller 312. The recovery current controller 312 may be connected to or in communication with an input power sensor 334. The recovery current controller 312 may cause the input power sensor 334 to monitor, or take regular measurements of, the input power to the server 308. When the recovery current controller 312 detects that the default power feed 318 has lost power and the switch 330 is switching power to the backup power feed 320, the recovery current controller 312 may measure the input power to the server 308 from the bulk capacitor 322. For example, the recovery current controller 312 may measure the voltage in the line at the input power sensor 334 and, using the rate of change of voltage, determine the power supplied to the server 308 by the bulk capacitor 322. The recovery current controller 312 may further be connected to the circuit switch 336 and control switching of the circuit switch 336.

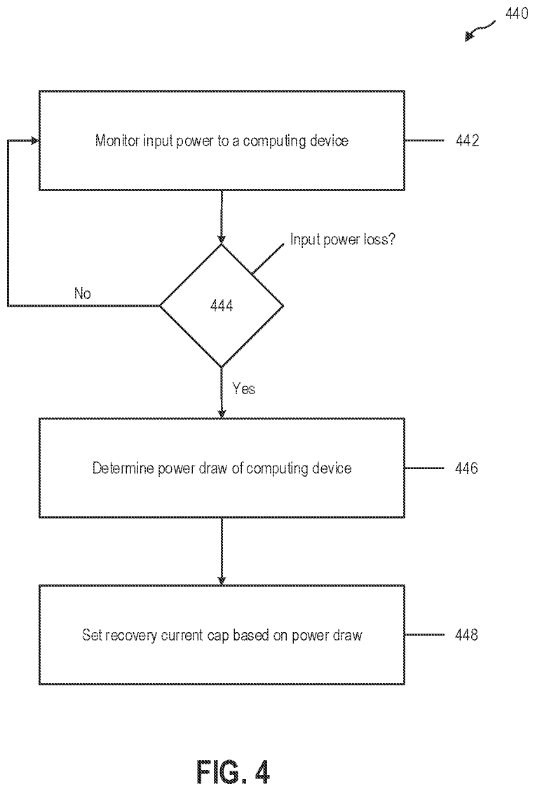

FIGS. 4, 5, and 7 the corresponding text, and the examples provide a number of different methods, systems, devices, and non-transitory computer-readable media of the PSU and/or the server. In addition to the foregoing, one or more embodiments can also be described in terms of flowcharts comprising acts for accomplishing a particular result, as shown in FIGS. 4, 5, and 7. FIGS. 4, 5, and 7 may be performed with more or fewer acts. Further, the acts may be performed in differing orders. Additionally, the acts described herein may be repeated or performed in parallel with one another or parallel with different instances of the same or similar acts.

As mentioned, FIG. 4 illustrates a flowchart of method 440 or a series of acts for limiting a recovery current, in accordance with at least one embodiment of the present disclosure. While FIG. 4 illustrates acts according to one embodiment, alternative embodiments may omit, add to, reorder, and/or modify any of the acts shown in FIG. 4. The acts of FIG. 4 can be performed as part of a method. Alternatively, a non-transitory computer-readable medium can comprise instructions that, when executed by one or more processors, cause a computing device to perform the acts of FIG. 4. In some embodiments, a system can perform the acts of FIG. 4.

A power sensor may monitor input power to a computing device, such as a server or other computing device, at 442. The power sensor may measure the input power with a measurement frequency. For example, the power sensor may measure the input power every 1 microsecond, every 2 microseconds, every 3 microseconds, every 4 microseconds, every 5 microseconds, every 10 microseconds, every 15 microseconds, every 20 microseconds, every 25 microseconds, every 30 microseconds, every 40 microseconds, every 50 microseconds, or any value therebetween.

Using the data from the power sensor, the recovery current controller may determine 444 whether there has been a loss of input power. For example, the recovery current controller may determine 444 whether the default power feed has lost power and whether the PSU is switching to the backup power feed. The recovery current controller may continuously monitor the input power. If the recovery current controller does not detect an input power loss, then the recovery current controller may continue to monitor the input power.

If the recovery current controller does detect a loss of input power, then the recovery current controller may determine a power draw of the computing device at 446. For example, as discussed herein, the recovery current controller may infer the power draw based on the rate of change of the voltage of a bulk capacitor during the switch between the default power feed and the backup power feed. In some embodiments, the recovery current controller may determine the power draw based on the power draw before the power switch. In some embodiments, the recovery current controller may determine the power draw based on the power draw while the recovery current is recharging the bulk capacitor.

The recovery current controller may set the recovery current cap based on the determined power draw at 448. For example, the recovery current controller may set the recovery current cap based on the power draw inferred by the rate of change of the voltage of the bulk capacitor. In some examples, the recovery current controller may set the recovery current cap based on the power draw measured before the switch from default to backup power. In some examples, the recovery current controller may set the recovery current cap based on the power draw measured during while recharging the bulk capacitor.

In some embodiments, the recovery current controller may adjust the recovery current cap during the switch between the default power feed and the backup power feed. For example, the recovery current controller may actively measure the power draw while the bulk capacitor is recharging. Because the power draw of the server may be variable, the recovery current controller may adjust the recovery current cap based on the active power draw during recharging. This may help to ensure that the bulk capacitor is recharged in a timely manner, even if the power consumption of the server increases during the recharge process.

The recovery current cap may be set based on any factor. For example, the recovery current cap may be set based on a percentage of the power draw. In some embodiments, the percentage may be in a range having an upper value, a lower value, or upper and lower values including any of 101%, 105%, 110%, 115%, 120%, 125%, 130%, 135%, 140%, 145%, 150%, 160%, 170%, 180%, 188% or any value therebetween. For example, the percentage may be greater than 101%. In another example, the percentage may be less than 188%. In yet other examples, the percentage may be any value in a range between 101% and 188%. In some embodiments, it may be critical that the percentage is between 101% and 150% to timely recharge the bulk capacitor while reducing or preventing tripping breakers and/or damaging the bulk capacitor and/or other components of the PSU.

As discussed herein, the method 440 may be performed at the PSU. For example, the PSU may include a recovery current controller installed on a processor at the PSU. The recovery current controller on the PSU may monitor the output power to the server, determine when the default power is switching to the backup power, and determine the output power to the server based on the rate of change of the voltage of the bulk capacitor. Locating the recovery current controller at the PSU may simplify operation of the recovery current controller by placing the control of the recovery current cap at the PSU and limiting the communication between different components.

In some embodiments, the method 440 may be performed at the server. For example, the recovery current controller may be installed on the BMC of a server. The recovery current controller may monitor the input power into the server. Based on fluctuations of the input power, the recovery current controller on the server may determine that the default power feed has lost power. The recovery current controller may determine the recovery current cap and transmit the cap to the PSU. Installing the recovery current controller at the server may allow for easy installation and maintenance of the recovery current controller.

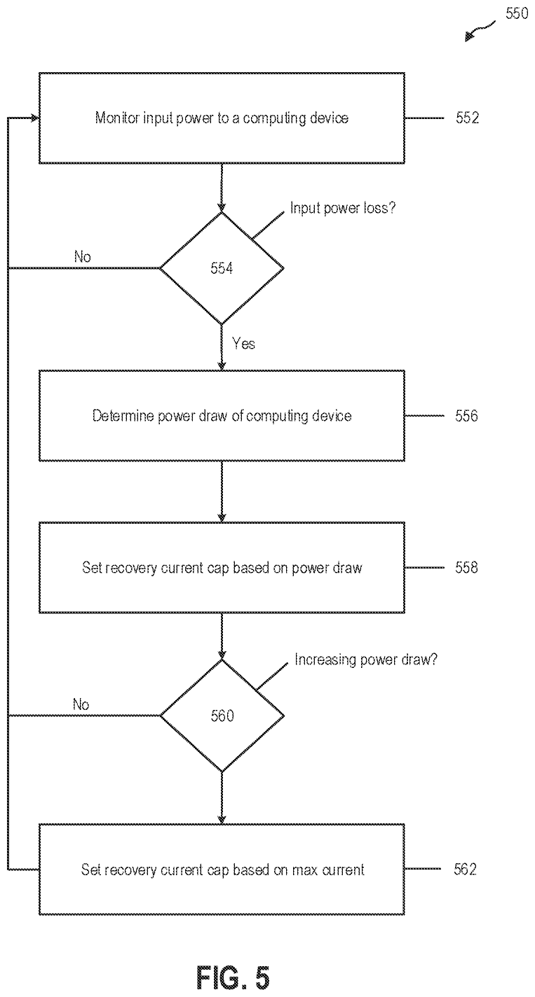

As mentioned, FIG. 5 illustrates a flowchart of a series of acts for limiting a recovery current, in accordance with at least one embodiment of the present disclosure. While FIG. 5 illustrates acts according to one embodiment, alternative embodiments may omit, add to, reorder, and/or modify any of the acts shown in FIG. 5. The acts of FIG. 5 can be performed as part of a method. Alternatively, a non-transitory computer-readable medium can comprise instructions that, when executed by one or more processors, cause a computing device to perform the acts of FIG. 5. In some embodiments, a system can perform the acts of FIG. 5.

A power sensor may monitor input power to a computing device, such as a server or other computing device, at 552. Using the data from the power sensor, the recovery current controller may determine 554 whether there has been a loss of input power. For example, the recovery current controller may determine 554 whether the default power feed has lost power and whether the PSU is switching to the backup power feed. The recovery current controller may continuously monitor the input power. If the recovery current controller does not detect an input power loss, then the recovery current controller may continue to monitor the input power.

If the recovery current controller does detect a loss of input power, then the recovery current controller may determine a power draw of the computing device at 556. For example, as discussed herein, the recovery current controller may infer the power draw based on the rate of change of the voltage of a bulk capacitor during the switch between the default power feed and the backup power feed. In some embodiments, the recovery current controller may determine the power draw based on the power draw before the power switch. In some embodiments, the recovery current controller may determine the power draw based on the power draw while the recovery current is recharging the bulk capacitor.

The recovery current controller may set the recovery current cap based on the determined power draw at 558. For example, the recovery current controller may set the recovery current cap based on the power draw inferred by the rate of change of the voltage of the bulk capacitor. In some examples, the recovery current controller may set the recovery current cap based on the power draw measured before the switch from default to backup power. In some examples, the recovery current controller may set the recovery current cap based on the power draw measured during while recharging the bulk capacitor.

In accordance with at least one embodiment of the present disclosure, the recovery current controller may continue to monitor the input power to the server. For example, the recovery current controller may monitor the power draw of the server during the switch between the default power and the backup power. If the recovery current controller determines that the power draw is within a threshold of the previously determined power draw, then the recovery current manager may loop back to the start of the method 550. If the recovery current controller determines 560 that there is an increasing power draw, then the recovery current cap may be based on the maximum current of the server and/or the PSU at 562. In this manner, the recovery current manager may set the recovery current cap, and allow for an increased recovery current cap if power usage by the server spikes while recharging the bulk capacitor.

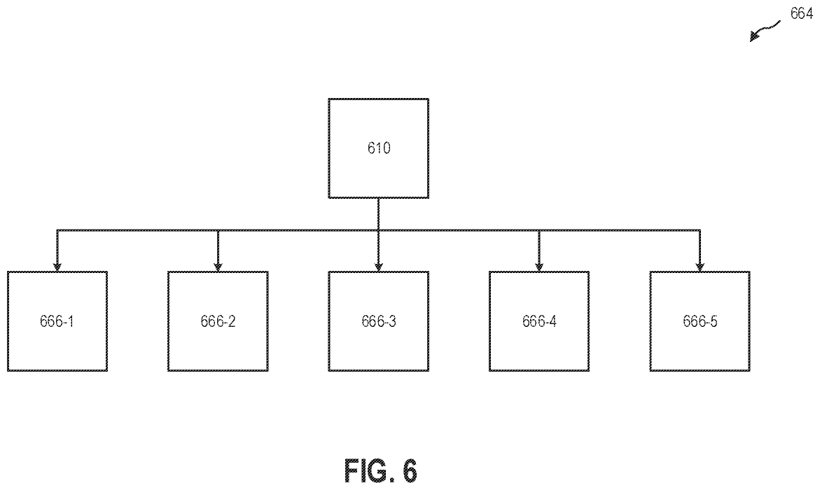

FIG. 6 is a representation of a recovery current controller 664 installed as firmware of a PSU 610, according to at least one embodiment of the present disclosure. The PSU 610 may be configured to provide power to a server configured to operate a virtual machine (VM). A particular type of VM may be described as having a particular VM profile. In the context of a cloud computing system, the term “VM profile” can refer to a particular combination of processing resources and memory resources utilized by a particular VM. Thus, in the simple example described above, VMs that emphasize processing capabilities may be associated with a particular VM profile, while VMs that emphasize storage capabilities may be associated with a different VM profile. Some cloud computing providers characterize different types of VMs as having different stock-keeping units, or SKUs. A SKU can be considered to be one example of a VM profile.

The PSU 610 may be configured to provide power to a server that may operate under a plurality of SKUs (collectively 666). Each SKU 666 may include the anticipated, average, or typical power consumption of a particular VM profile of the server. For example, a SKU 666 for a VM profile associated with a compute node may have a higher power consumption than a SKU 666 for a VM profile associated with a storage node. In the embodiment shown, the recovery current controller 664 includes five SKUs 666, including a first SKU 666-1, a second SKU 666-2, a third SKU 666-3, a fourth SKU 666-4, and a fifth SKU 666-5. Each of the SKUs 666 may have a different power rating or anticipated power consumption. While five SKUs 666 are shown in FIG. 6, the PSU 610 may be associated with any number of SKUs, including 1, 2, 3, 4, 5, 6, 7, 8, 9, 10, or any other number of SKUs, based on the types of VM profiles that the server may utilize.

When the VM of the server is established, the PSU 610 may determine the SKU 666 for the server. For example, the server may communicate the particular SKU 666 to the PSU 610. In some examples, the PSU 610 may determine that the server is operating with a particular SKU 666 based on a detected power consumption pattern. In some examples, the PSU 610 may determine that the server is operating with a particular SKU 666 based on a communication received from an external computing device.

When the PSU 610 determines the SKU 666 of the server, the PSU 610 may provide power to the server based on the power profile associated with the SKU 666. In some embodiments, PSU 610 may include a recovery current cap associated with each of the SKUs 666. The recovery current cap may be fixed, based on the anticipated power consumption of the server associated with the SKU 666. Because the server will operate within the operating parameters of the VM profile associated with the SKU 666, setting a hard recovery current cap based on the SKU 666 may allow the bulk capacitor to be recharged without actively monitoring the power consumption during the switch from default power to backup power.

In accordance with at least one embodiment of the present disclosure, the PSU 610 may be overpowered relative to the server. Put another way, the maximum available power that the PSU 610 may supply to the server may be larger than the maximum power consumption of the server. As discussed herein, an overpowered PSU 610 may trip breakers while recharging the bulk capacitor and/or damage components of the data center, including the servers and/or the bulk capacitor.

The recovery current controller 664 may set the recovery current cap at the firmware of the PSU 610 to be less than the maximum available power of the PSU 610. As discussed herein, the recovery current cap may be set based on the anticipated power consumption of the server operating under the registered SKU 666. Setting the recovery current cap in the firmware of the PSU 610 may reduce the complexity of the recovery current controller 664 by not using any power use or consumption sensors or other elements.

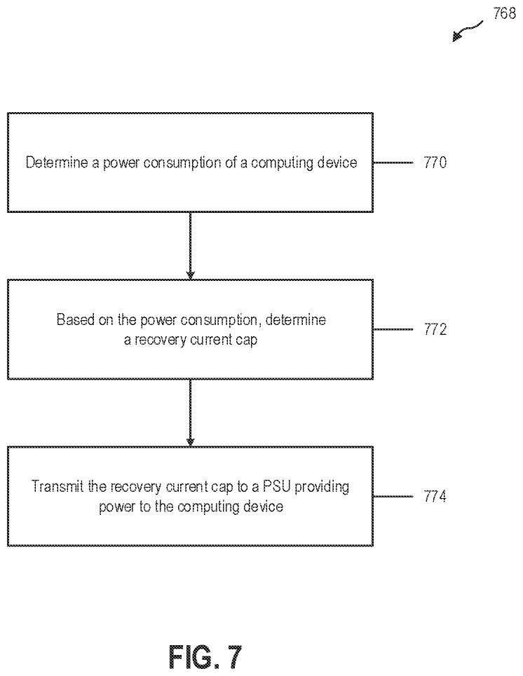

As mentioned, FIG. 7 illustrates a flowchart of method 768 or a series of acts for limiting a recovery current, in accordance with at least one embodiment of the present disclosure. While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer-readable medium can comprise instructions that, when executed by one or more processors, cause a computing device to perform the acts of FIG. 7. In some embodiments, a system can perform the acts of FIG. 7.

A recovery current controller may be located at a server. For example, the recovery current controller may be installed on the BMC of the server such that the recovery current controller may apply the recovery current cap regardless of the VM profile or SKU of the application of the server. The recovery current controller may determine a power consumption of a computing device at 770. For example, the recovery current controller may determine the input power to the computing device using an input power sensor. In some embodiments, the PSU may determine the input power and transmit the input power to the recovery current controller. In some embodiments, the recovery current controller may determine the power consumption of the computing device using any other mechanism.

The recovery current controller may, based on the power consumption, determine a recovery current cap for the recovery current at 772. In some embodiments, as discussed herein, the recovery current cap may be a percentage of the determined power consumption.

The recovery current controller may transmit the recovery current cap to the PSU that provides power to the computing device at 774. In some embodiments, the recovery current controller may transmit the recovery current cap to the PSU if the recovery current controller determines that the default power feed has lost power and the PSU has switched to the backup power feed. The recovery current controller may transmit the recovery current cap during the switch between the default power feed and the backup power feed. The recovery current controller may transmit the recovery current cap after the switch between the default power feed and the backup power feed.

In some embodiments, as discussed herein, the recovery current controller may determine the power consumption and the recovery current cap during the switch between the default power feed and the backup power feed. In this manner, the recovery current controller may provide the recovery current cap based on the power consumption during the switch so that the recovery current cap is representative of recent power consumption levels of the computing device. In some embodiments, the recovery current controller may determine the power consumption and the recovery current cap after the switch between the default power feed and the backup power feed. In this manner, the recovery current controller may provide the recovery current cap based on the power consumption while charging the bulk capacitor.

In some embodiments, the recovery current controller may transmit the recovery current cap to the PSU during the switch between the default power feed and the backup power feed. This may set the recovery current cap before the backup power feed is connected, thereby preventing a momentary recovery current above the recovery current cap. In some embodiments, the recovery current controller may transmit the recovery current cap to the PSU after the switch to between the default power feed and the backup power feed. This may set the recovery current cap based on all the power consumption information available during the switch.

In some embodiments, the recovery current controller may transmit the recovery current cap to the PSU before the default power feed loses power. For example, the recovery current controller may periodically transmit the recovery current cap to the PSU. When the default power feed loses power, the PSU may utilize the most recently transmitted recovery current cap. In this manner, the PSU may have a recovery cap in place, thereby reducing or preventing the chance of not receiving the recovery current cap before the backup power feed is connected.

In some embodiments, if the PSU has not received a recovery current cap, the PSU may utilize pre-determined recovery current caps. For example, as discussed herein, the PSU may include one or more recovery current caps stored in the firmware of the PSU. If the PSU does not receive the recovery current cap from the server, the PSU may utilize the recovery current cap stored in the firmware of the PSU. In some embodiments, the PSU and the server may each include a recovery current manager, as discussed herein.

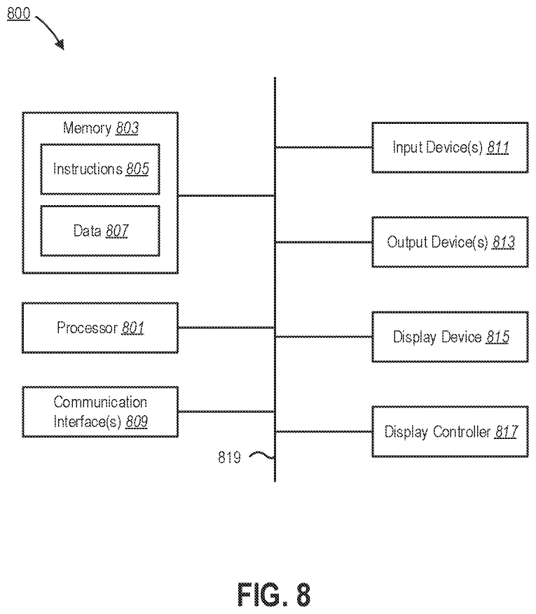

FIG. 8 illustrates certain components that may be included within a computer system 800. One or more computer systems 800 may be used to implement the various devices, components, and systems described herein.

The computer system 800 includes a processor 801. The processor 801 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 801 may be referred to as a central processing unit (CPU). Although just a single processor 801 is shown in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 805 and data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during execution of the instructions 805 by the processor 801.

A computer system 800 may also include one or more communication interfaces 809 for communicating with other electronic devices. The communication interface(s) 809 may be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 800 may also include one or more input devices 811 and one or more output devices 813. Some examples of input devices 811 include a keyboard, mouse, microphone, remote control device, button, joystick, trackball, touchpad, and lightpen. Some examples of output devices 813 include a speaker and a printer. One specific type of output device that is typically included in a computer system 800 is a display device 818. Display devices 818 used with embodiments disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 818.

The various components of the computer system 800 may be coupled together by one or more buses, which may include a power bus, a control signal bus, a status signal bus, a data bus, etc. For the sake of clarity, the various buses are illustrated in FIG. 8 as a bus system 819.

### INDUSTRIAL APPLICABILITY

Following are sections in accordance with embodiments of the present disclosure:
A1. A method for limiting recovery current, comprising:
   monitoring power of a power supply unit (PSU) to a computing device;
   determining a loss of the power to the computing device; and
   based at least in part a power consumption of the computing device, setting a recovery current cap for the PSU.
A2. The method of section A1, further comprising determining a power consumption of the computing device.
A3. The method of section A1 or A2, further comprising determining a rate of change of voltage of a bulk capacitor, and wherein the recovery current cap is based at least in part on the rate of change of the voltage.
A4. The method of section A3, wherein the bulk capacitor is coupled to an uninterruptable power supply (UPS).
A5. The method of section A3 or A4, further comprising determining a power draw of the computing device based on the rate of change of the voltage.
A6. The method of section A5, wherein setting the recovery current cap is based at least in part on the power draw of the computing device.
A7. The method of section A6, wherein setting the recovery current cap includes setting the recovery current cap as a percentage of the power draw.
A8. The method of section A7, wherein the percentage is between 101% and 150%.
A9. The method of any of sections A1-A8, wherein monitoring the power includes monitoring the power provided by the PSU to the computing device.
A10. The method of any of sections A1-A9, wherein the PSU has a maximum available power of at least 3 times a power draw of the computing device.
A11. The method of any of sections A1-A10, wherein the recovery current cap is less than a maximum available power of the PSU.
B1. A power supply unit (PSU), comprising:
   an input power configured to supply power to a computing device, the computing device having an anticipated power consumption, wherein the PSU has a maximum available power of at least three times the anticipated power consumption;
   a bulk capacitor configured to provide power to the computing device during a switch between a default power feed and a backup power feed; and a memory and processor in the PSU, the memory including instructions which, when accessed by the processor, set a recovery current cap that is less than the maximum available power.
B2. The PSU of section B 1, wherein the instructions further include instructions which, when accessed by the processor, determine a stock keeping unit (SKU) of a virtual machine (VM) profile of the computing device, the recovery current cap being based on the SKU.
B3. The PSU of section B 1 or B2, wherein the anticipated power consumption is based on a virtual machine (VM) profile of the computing device.
B4. The PSU of any of sections B1-B3, wherein the instructions are located in firmware for the PSU.
C1. A method for limiting a recovery current, comprising:
   at a computing device, determining a power consumption of the computing device;
   based on the power consumption, determining a recovery current cap; and
   transmitting the recovery current cap to a power supply unit (PSU) providing power to the computing device.
C2. The method of section C1, wherein transmitting the recovery current cap includes transmitting the recovery current cap during a switch between a default power feed and a backup power feed.
C3. The method of section C1 or C2, wherein transmitting the recovery current cap includes transmitting the recovery current cap before a switch between a default power feed and a backup power feed.
C4. The method of any of sections C1-C3, wherein determining the recovery current cap includes setting the recovery current cap to between 101% and 150% of the power consumption.
C5. The method of any of sections C1-C4, wherein determining the recovery current cap includes setting the recovery current cap to less than a maximum available power of the PSU.

One or more specific embodiments of the present disclosure are described herein. These described embodiments are examples of the presently disclosed techniques. Additionally, in an effort to provide a concise description of these embodiments, not all features of an actual embodiment may be described in the specification. In the development of any such actual implementation, as in any engineering or design project, numerous embodiment-specific decisions will be made to achieve the developers' specific goals, such as compliance with system-related and business-related constraints, which may vary from one embodiment to another. Moreover, such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for limiting recovery current, comprising:
monitoring power of a power supply unit (PSU) to a computing device;
determining a loss of the power to the computing device; and
based at least in part a power consumption of the computing device, setting a recovery current cap for the PSU.

2. The method of claim 1, further comprising determining a power consumption of the computing device.

3. The method of claim 1, further comprising determining a rate of change of voltage of a bulk capacitor, and wherein the recovery current cap is based at least in part on the rate of change of the voltage.

4. The method of claim 3, wherein the bulk capacitor is coupled to an uninterruptable power supply (UPS).

5. The method of claim 3, further comprising determining a power draw of the computing device based on the rate of change of the voltage.

6. The method of claim 5, wherein setting the recovery current cap is based at least in part on the power draw of the computing device.

7. The method of claim 6, wherein setting the recovery current cap includes setting the recovery current cap as a percentage of the power draw.

8. The method of claim 7, wherein the percentage is between 101% and 150%.

9. The method of claim 1, wherein monitoring the power includes monitoring the power provided by the PSU to the computing device.

10. The method of claim 1, wherein the PSU has a maximum available power of at least 3 times a power draw of the computing device.

11. The method of claim 1, wherein the recovery current cap is less than a maximum available power of the PSU.

12. A power supply unit (PSU), comprising:
an input power configured to supply power to a computing device, the computing device having an anticipated power consumption, wherein the PSU has a maximum available power of at least three times the anticipated power consumption;
a bulk capacitor configured to provide power to the computing device during a switch between a default power feed and a backup power feed; and
a memory and processor in the PSU, the memory including instructions which, when accessed by the processor, set a recovery current cap that is less than the maximum available power.

13. The PSU of claim 12, wherein the instructions further include instructions which, when accessed by the processor, determine a stock keeping unit (SKU) of a virtual machine (VM) profile of the computing device, the recovery current cap being based on the SKU.

14. The PSU of claim 12, wherein the anticipated power consumption is based on a virtual machine (VM) profile of the computing device.

15. The PSU of claim 12, wherein the instructions are located in firmware for the PSU.

16. A method for limiting a recovery current, comprising:
at a computing device, determining a power consumption of the computing device;
based on the power consumption, determining a recovery current cap; and
transmitting the recovery current cap to a power supply unit (PSU) providing power to the computing device.

17. The method of claim 16, wherein transmitting the recovery current cap includes transmitting the recovery current cap during a switch between a default power feed and a backup power feed.

18. The method of claim 16, wherein transmitting the recovery current cap includes transmitting the recovery current cap before a switch between a default power feed and a backup power feed.

19. The method of claim 16, wherein determining the recovery current cap includes setting the recovery current cap to between 101% and 150% of the power consumption.

20. The method of claim 16, wherein determining the recovery current cap includes setting the recovery current cap to less than a maximum available power of the PSU.
